(19) United States
(12) Patent Application Publication
(10) Pub. No.: US 2012/0300226 A1
(43) Pub. Date: Nov. 29, 2012

(54) SALES DEVICE FOR PRODUCING A BANNER

(75) Inventors: Olivier Maarten Janssen, Amsterdam (NL); Thibaud Hendrik Bruna, Amsterdam (NL)

(73) Assignee: OLIVIER JANSSEN HOLDING BV, Amsterdam (NL)

(21) Appl. No.: 13/511,757

(22) PCT Filed: Nov. 24, 2010
(86) PCT No.: PCT/NL2010/050783

§ 371 Date: Aug. 14, 2012

(30) Foreign Application Priority Data
Nov. 24, 2009 (NL) 2003858

(51) Int. Cl. G06K 15/02; G06K 15/16

(52) U.S. Cl. 358/1.2

(57) ABSTRACT

Sales device for producing a banner (7) with a computer system (10) which is connected to a user interface (3) and a printing installation (11). The user interface (3) is designed to receive order instructions from a user. The printing installation (11) is designed to print on a banner (7) with a previously defined size according to the order instructions, and includes a printer (12) to print on banner material, a material holder (13) for a supply of banner material, and a cut-off mechanism (14) to cut off the banner material.

### FIELD OF THE INVENTION

The present invention relates to a sales device or kiosk for producing a banner, comprising a computer system which is connected to a user interface and a printing installation, wherein the user interface is designed to receive order instructions from a user.

### PRIOR ART

The international patent publication WO00/58850 discloses a photo kiosk at which a user can take a photo of himself and process and store this photo in an electronic file (on a medium to be selected), in order, for example, to send this by e-mail. This publication indicates that sending the electronic file is an alternative to other hitherto conventional systems, wherein the user can print out a processed photo on photo paper in standard available formats (single, multiple prints, or even photo stickers, see, for example, U.S. Pat. No. 5,623,581).

### SUMMARY OF THE INVENTION

The present invention seeks to provide a variant of the photo kiosk, with which it is possible to compose and produce a banner at a location. Current photo kiosks are not equipped to print on large pieces of material that are required to produce banners.

According to the present invention, a sales device of the type defined in the preamble is provided, wherein the printing installation is designed to print on a banner with a predefined size according to the order instructions, wherein the printing installation comprises a printer for printing on banner material, a material holder for a supply of banner material, and a cut-off mechanism to cut off the banner material.

By providing a material holder with a sufficient capacity, it is possible to allow the sales device to operate autonomously for a specific period. Due to the provision of a cut-off mechanism, a flexible operation of the sales device is possible, as a result of which a user can specify any required length of the banner as an order instruction.

It is noted that the American patent publication US2009/0196667 discloses a printing installation for banners, wherein the printer guides the banner material through the printer in such a way that both sides of the banner material can be printed. This publication merely discloses details and elements of the guiding system in the printer.

In one embodiment, the material holder is provided with a drive for the tension-free (i.e. without excessive required tractive force) feeding of the banner material to the printer. Standard printers cannot easily interwork with a large-capacity material holder of this type. By using a drive in the material holder, it is possible to feed the banner material to the printer without tension.

In a further embodiment, the sales device is provided with a blocking device for a closable output area for the temporary storage of a banner during the printing process, and the computer system is designed to control the blocking device to open the closable output area once the banner is ready. This prevents a user from pulling on the banner before it is ready and possibly from overloading or even damaging the printer or parts thereof.

In one embodiment, the sales device is furthermore provided with an accessory output device. With this, it is also possible to provide accessories such as pins, string and other fixing means via the sales device for use together with the produced banner.

In another further embodiment, the printer is provided with a refillable ink supply. By selecting the capacity as sufficiently large, the sales device can be in operation during a long period without the need for interim maintenance or logistics operations in situ.

In a further embodiment, the sales device furthermore comprises a management interface which is connected to the computer system. All manner of logistical data from a plurality of sales devices can thus be collected centrally, and logistics management can be carried out from a central point. Even remote diagnostics can possibly be implemented, by means of which a fault can first be analysed and appropriate measures can be taken.

In a further embodiment, the sales device furthermore comprises a payment device which is connected to the computer system. The payment device can be implemented as a physical device (for example a credit card or cheque guarantee card machine, a coin and note machine), but a non-tangible variant is also possible (payment via mobile telephone, nft ('near-field transmission') system, or via a payment code).

In a further embodiment, the sales device furthermore comprises a data interface which is connected to the computer system. With this, the user can, for example, load in photos or images which can be printed out on the banner.

In another further embodiment, the computer system is designed to load previously stored banner designs from a central computer system to produce a banner. Thus, the user can create a design in advance (for example at home) and then produce the banner at the place of destination via the sales device.

### BRIEF DESCRIPTION OF THE DRAWINGS

The present invention will now be discussed in more detail on the basis of a number of example embodiments, with reference to the attached drawings, in which:

FIG. 1 shows a front view of a sales device according to one embodiment of the present invention; and

FIG. 2 shows a block diagram of a sales device according to one embodiment of the present invention.

### DETAILED DESCRIPTION OF EXAMPLE EMBODIMENTS

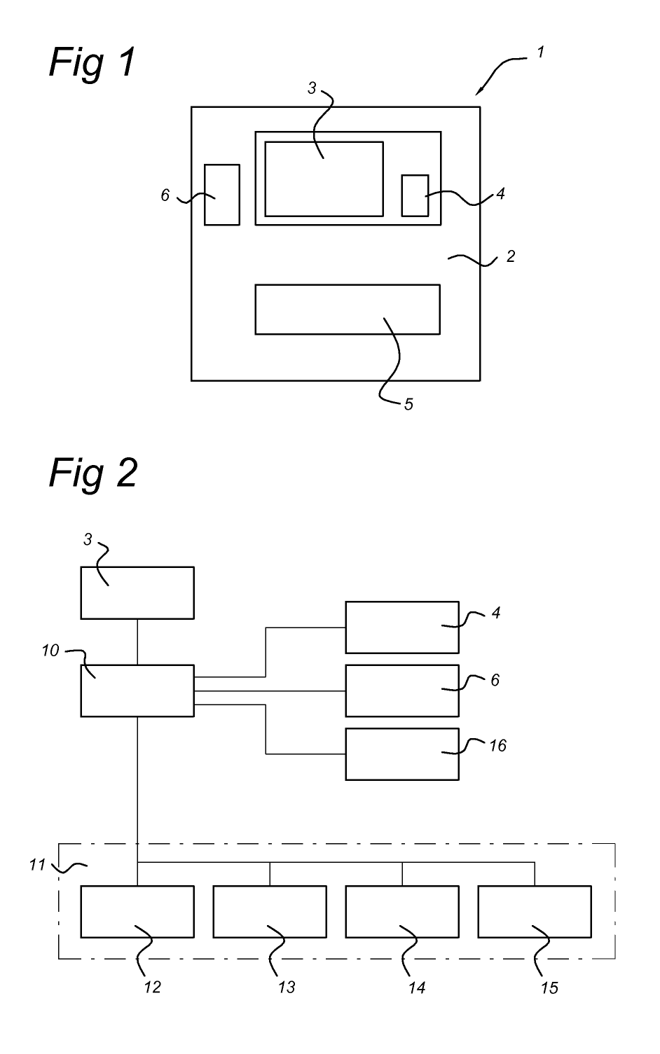

FIG. 1 shows a front view of the sales device 1 in the form of a kiosk ('vending machine') for the sale and in situ production of a banner 7. A banner 7 may be made from various types of material, such as paper, canvas or other suitable materials. In most cases, the length of the banner 7 will be a multiple of the width of the banner 7, but banners 7 can also be made in the form of, for example, nameplates in a smaller format.

As shown in the example embodiment presented in FIG. 1, the sales device 1 comprises a user interface 3, for example in the form of a touch screen, which is located in a compartment 2. In the compartment 2, an output area 5 is also provided, in which a banner 7 can be accommodated and removed following production. In one embodiment, the output area 5 is provided with a controllable closure, for example in the form of a blockable flap. The compartment 2 also provides space for other components and elements of the sales device 1, as will be explained below with reference to the block diagram shown in FIG. 2. One advantage of a compartment 2 of this type is that it can be attractively designed in accordance with the intended use and the location of use.

In alternative embodiments, the user interface 3 may comprise additional and/or different elements, such as a monitor, keyboard, mouse, track ball, camera, etc., with which a user can enter his requirements for the production of a banner 7 into the sales device 1.

Furthermore, the outside of the sales device 1 may be provided with a payment device 4, for example in the form of a card reader for payment cards and credit cards, and/or a coin and note machine. In a further alternative, the sales device 1 may also be provided with a further interface 6, for example a memory card reader or USB interface, with which, for example, photo files can be loaded into the sales device 1. The sales device 1 may be located, inter alia, in airports, at stadiums, sporting arenas, concerts, festivals, events, promotional locations, live shows, elections, at universities, schools, to support brand activations, in supermarkets, department stores, filling stations, shops, party outlet stores, etc.

FIG. 2 shows a schematic block diagram of various components which form part of the sales device 1. The central component is a computer system 10, for example in the form of a CPU-based computer system, which, as is known to the person skilled in the art, operates with the aid of an operating system such as Windows, Linux, etc. Furthermore, the computer system 10 comprises conventional components such as memories for temporary and permanent storage of data (usage data, software programs, etc.), and a number of interface circuits for communication with peripheral devices. In the computer system 10, a software program can run which controls the communication between the various parts of the sales device 1 and guides the user through the usage process.

The peripheral devices comprise, inter alia, the aforementioned user interface 3, which is connected to the computer system 10. The computer system 10 is designed to display images on the user interface 3, and to receive input data from the user interface 3, for example order instructions entered by a user.

The peripheral devices furthermore comprise a printing installation 11 for the production, under the control of the computer system 10, of a banner 7 with the predefined size according to the order instructions.

The printing installation 11 comprises various components, such as the printer 12 which ensures the printing on blank or pre-printed banner material. The banner material is provided from a material holder 13. The material holder 13 is, for example, a large supply of banner material such as paper or canvas or a roll which has sufficient capacity (for example in the order of magnitude of several hundred metres) so that the sales device 1 can be in operation for a defined period without the need for refilling (for example one week).

The printer 12 is designed for the input of a strip of banner material in a manner which is comparable with conventional printers. The tractive force of the drive rollers in a printer 12 is usually limited, as a result of which it is difficult to draw an entire banner 7 from the material holder 13 through the printer 12. For this reason, the material holder 13 is provided in one embodiment with a drive under the control of the computer system 10 (directly or via the printer 12). The drive comprises, for example, a step motor which always unrolls a defined length of banner material from the material holder 13. The drive of the material holder 13 is designed in such a way that, synchronously with the printing process, a defined length of banner material is available in each case to the printer 12 without tension or tractive force. In this way, a standard printer 12 can be used without modifications to the feed system of the material to be printed on.

In a further embodiment, the printer 12 is provided with a (refillable) supply of printing material (ink in the case of an inkjet printer 12 or toner in the case of a laser printer 12) which has sufficient capacity to maintain the printer 12 in operation for a defined period (for example one week) without the need for refilling of the printing material. The printing material may comprise black ink/toner, but also colour ink/toner, for example in large-format containers or cartridges.

The printing installation 11 is also provided with a cut-off mechanism 14, which is also controlled by the computer system 10 (directly or via the printer 12). As soon as the correct length of the banner 7 according to the order instructions is unrolled from the material holder 13, the cut-off mechanism 14 is controlled to cut off the banner material to this length. A further advantage of a large supply of banner material in a continuous form on the material holder 13 in combination with the cut-off mechanism 14 is that a user can determine entirely for himself how long a banner 7 must be, as a result of which a more flexible use is made possible.

In a further embodiment, the printing installation 11 is provided with a blocking control 15 for the output area 5. As long as the printing process of a banner 7 is in progress, the output area 5 is closed or blocked (for example with a flap), so that a user cannot pull on the part of the banner 7 which is already printed. This prevents any damage or disruption to the printer 12.

The blocking control 15 can also be used together with the output area 5 as an accessory output device in order, for example, to provide pins or fixing means (string, adhesive tape, etc.) for a banner 7, again under the control of the computer system 10. An associated and separate supply holder is also provided for this purpose in the compartment 2 of the sales device 1.

As described above with reference to FIG. 1, the sales device is provided with a payment device 4. The latter communicates with the computer system 10, and with the external components associated with a payment device 4, such as bank computers and the like. The payment device 4 may be provided with a physical interface on the outside of the compartment 2 (as shown in FIG. 1), but, as an alternative, the payment device 4 may also be designed for payment via a different medium, such as via a mobile telephone, nft (near-field transmission) chips, or input of a payment code, wherein no external element is required in the compartment 2. The computer system 10 determines, for example, that an ordering process only goes through after a confirmation of a payment has been received (authorisation).

In a further embodiment, the sales device 1 is furthermore provided with a management interface 16 which is connected to the computer system 10. The computer system 10 may, for example, maintain all kinds of logistical data with use of associated sensors relating to the consumption of banner material, ink/toner and other accessories. A manager of the sales device 1 can then centrally and remotely maintain data, such as financial data (revenue/turnover), status and settings of the sales device 1, and consumption data, so that action can be taken in a timely manner for the correct logistics actions or maintenance work. The management interface 16 may be implemented as a data link in various forms, for example via a telephone line connection or a WiFi connection.

As also indicated with reference to the view drawing in FIG. 1, a data interface 6 can furthermore be disposed in the compartment 2, similarly communicating with the computer system 10. Thus, for example, photo files can be loaded in by a user, which, following processing and combination with input text, can be printed on the banner 7. With one of the embodiments of the sales device 1 as described above, the public can make a banner 7 in situ. This may or may not involve payment, depending on the venue (for example free of charge at sponsored events).

The usage process of the sales device 1 comprises in principle the following steps which are implemented by the computer system 10, for example via a software program, via the user interface 3. First of all, a format is chosen for the banner 7. A payment is then made with a credit card, PIN, chip, cash, via a mobile telephone or via a code purchased on the Internet site (via the payment device 4). The banner 7 is then composed on the user interface 3. A choice can be made from various languages, colours, fonts, emoticons, logos and other images and formats or previously stored templates. Finally, (following a visual check via the user interface 3), the order is given to print. The sales device 1 indicates that the printing process is in progress and, as soon as it is completed, the customer can retrieve the banner 7 from the output area 5. In a further embodiment, the management interface 16 can be designed to allow the computer system to communicate with the Internet. In this embodiment, it is then possible, for example, that a customer creates a design in advance via a web interface or on a central computer system, and that subsequently, at the location where the banner 7 will be used, the design is reloaded from the central computer system and produced via a sales device 1.

In one embodiment, the management of the different parts of the sales device 1 is implemented as software (modules, programs) which, for example, is executed on the computer system 10. The computer system 10 comprises, for example, a processor and a memory unit connected to the processor, such as a hard disk and/or semiconductor memory, and an input/output unit. The input/output unit is connected to the various peripheral devices 3, 4, 6, 11, 16 as discussed above.

A further example of a peripheral device is a read unit to read computer-executable instructions into the memory of the computer system 10. The read unit can be designed to read data (such as computer-executable instructions) from and possibly store data on a computer program product, such as a floppy disk or CD-ROM. Other comparable data media may be, for example, memory sticks, DVDs or Blu-ray discs, as known to the person skilled in the art.

The processor in the computer system 10 may be implemented as a stand-alone system or as a number of parallel-operating processors, each one being designed to execute subroutines of a larger program, or as one or more main processors with various subprocessors.

The present invention has been described in detail above with reference to embodiments and examples. It will be clear to the person skilled in the art that various parts of the discussed embodiments can be implemented in a different way, while still achieving the same result. The scope of protection of the present application is then also determined by the elements and equivalents thereof defined in the claims.

1-9. (canceled)

10. A sales device for producing a banner, comprising a computer system which is connected to a user interface and a printing installation, wherein the user interface is designed to receive order instructions from a user,
characterized in that the printing installation is designed to print on a banner with a predefined size according to the order instructions,
wherein the printing installation comprises
a printer to print on banner material;
a material holder for a supply of banner material; and
a cut-off mechanism to cut off the banner material.

11. The sales device of claim 10, wherein the material holder is provided with a drive for the tension-free feed of banner material to the printer.

12. The sales device of claim 10, wherein the sales device is provided with a blocking device for a closable output area for the temporary storage of a banner during the printing process, and wherein the computer system is designed to control the blocking device to open the closable output area once the banner is ready.

13. The sales device of claim 10, wherein the sales device is furthermore provided with an accessory output device.

14. The sales device of claim 10, wherein the printer is provided with a refillable ink supply.

15. The sales device of claim 10, wherein the sales device furthermore comprises a management interface which is connected to the computer system.

16. The sales device of claim 10, wherein the sales device furthermore comprises a payment device which is connected to the computer system.

17. The sales device of claim 10, wherein the sales device furthermore comprises a data interface which is connected to the computer system.

18. The sales device of claim 10, wherein the computer system is designed to load previously stored banner designs from a central computer system to produce a banner.
